(19) United States
(12) Patent Application Publication
(10) Pub. No.: US 2006/0064867 A1
(43) Pub. Date: Mar. 30, 2006

(54) Method for preassembly of membrane electrode assemblies and assembly of proton exchange membrane fuel cell stacks

(76) Inventor: William R. Richards, Springfield, VA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/234,296

(22) Filed: Sep. 26, 2005

Related U.S. Application Data
(60) Provisional application No. 60/612,534, filed on Sep. 24, 2004.

(51) Int. Cl. H01M 6/00

(52) U.S. Cl. 29/623.1

(57) ABSTRACT

A single membrane electrode assembly (MEA) is assembled from an anode side gas diffusion media (GDM), a rigid precision thickness plastic gasket, a complementary cathode side gas diffusion media and another rigid precision thickness plastic gasket. The MEA preassembly is assembled with outer protective plastic film layers that are removed prior to the assembly of the MEAs, which are sandwiched between successive bi-polar plates in a multicell proton exchange membrane fuel cell (PEMFC) stack configuration.

### FIELD OF THE INVENTION

The invention relates to a method of assembling membrane electrode assembly (MEA) preassembly using an alignment fixture. Additionally, the alignment fixture is suitable for assembly of MEA preassemblies into a proton exchange membrane fuel cell (PEMFC) stack.

### BACKGROUND OF THE INVENTION

A need exists for the rapid assembly of membrane electrode preassemblies, which are assembled from various components. The membrane electrode assemblies are component parts of a proton exchange membrane fuel cell (PEMFC). Typically, a PEMFC stack has a plurality of MEAs, however the assembly of such MEAs has been difficult to accomplish in a rapid manner with gas diffusion media. An MEA is essentially flimsy and therefore difficult to manipulate without wrinkling. Further, assembly of a plurality of MEAs in a fuel cell stack has not been accomplished in a uniform manner involving steps that are able to be repeated for efficient assembly of the MEAs in the PEMFC stack configurations.

### SUMMARY OF THE INVENTION

As an object of the present invention to provide a method for the assembly of membrane electrode assemblies and for the assembly of MEAs in a multicell proton exchange membrane fuel cell stack configuration.

It is a further object of the invention to achieve assembly of membrane electrode assemblies using an alignment jig for aligning the components with an MEA and for aligning MEA preassemblies in a multi-cell proton exchange membrane fuel cell stack configuration.

### BRIEF DESCRIPTION OF THE DRAWINGS

FIG. 1 is a view showing assembly of a membrane electrode assembly (MEA) and components on an alignment fixture to provide a MEA Preassembly.

FIG. 2 is a view of a vacuum plate used for positioning the MEA in the assembly step of FIG. 1.

FIG. 3 is a side view of the vacuum plate.

FIG. 4 is a sectional view of a portion of the vacuum plate shown in FIG. 2.

### DESCRIPTION OF THE PREFERRED EMBODIMENTS

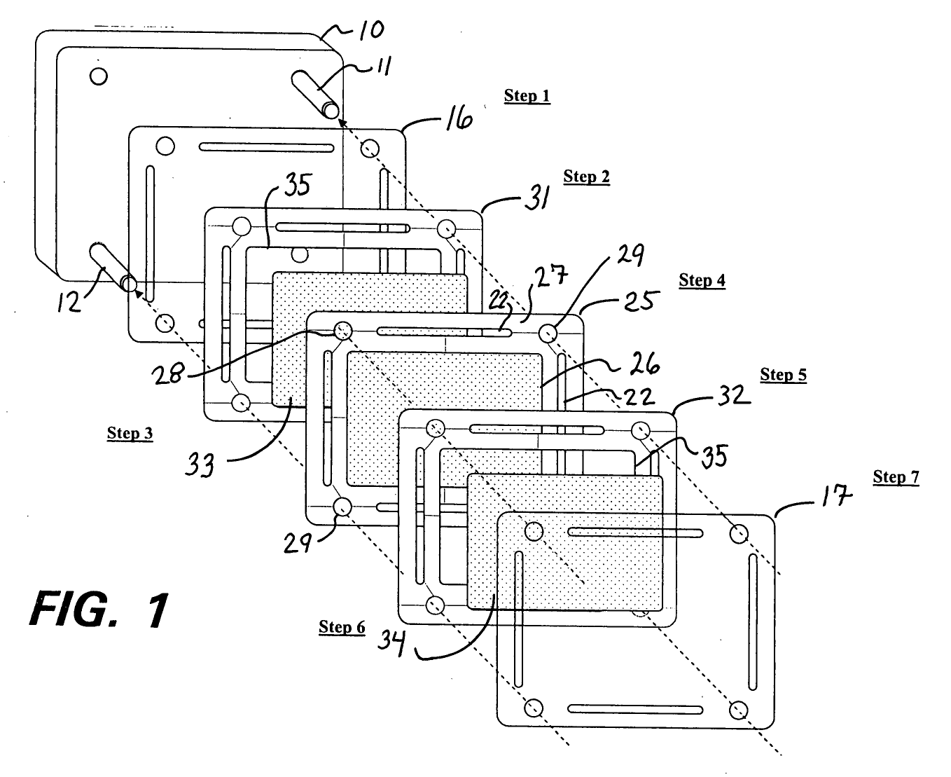

Attempting to assemble a multi-cell stack configuration from its constituent parts is a labor-intensive process. One of the most difficult problems is in the handling of the proton exchange membrane (PEM) itself. Nafion® PFSA membranes by DuPont are widely used for Proton Exchange Membrane (PEM) fuel cells. The PEM membranes are specified to be supplied from the manufacturer and these membranes are available with electrodes attached and sold as MEAs or membrane electrode assemblies. By specifying the dimensions and configurations as shown in FIG. 1, the MEAs, although not in the prior art, are commercially available.

Proper position and alignment between the associated gas diffusion media (GDM) and sealing gasket elements in a manner that eliminates any resultant wrinkling of the MEA prior to the stack being clamped together is important. Any wrinkling will contribute to increased difficulty in stack sealing of both the fuel and reactant gases leaking out of the stack into the environment, and/or of crossover of fuel and reactant gases such that parasitic levels of water generation result as hydrogen and air mixes in an uncontrolled manner.

An un-hydrated MEA is notoriously difficult to handle due to its thinness (approximately 0.0015 inches thick) and is susceptible to inadvertent stretching during handling (even when reinforced with a micro structural element) as it is placed into the cell structure. Similarly, a partially hydrated MEA (due to varying ambient level of relative humidity (RH) in the assembly area or storage cabinet) can also cause undesirable dimensional changes, due to moisture absorption, that could easily reach 3% or more in the X and Y dimensions. Finally, the MEA is susceptible to being inadvertently brought into proximity with the gasket material that is positioned adjacent the MEA, either statically or adhesively adhering. This “grabbing” causes the PEM to not become fully stretched into the full X, Y dimensions, and wrinkling results. The MEA must then be manipulated and/or “rearranged” until any visible wrinkling is eliminated.

A wrinkle-free installation capability for the MEA, which provides for substantially higher structural rigidity of the MEA itself is achieved by incorporating the MEA into a “MEA Preassembly”. The higher structural rigidity is achieved by taking advantage of the greatly increased section modulus of the multi-element composite sandwich structure of the MEA preassembly. This takes into account the elastic modulus properties for both gaskets and gas diffusion media (GDMs) which become integral parts of the composite sandwich structure of the MEA preassembly. This greatly increases rigidity and facilitates the ease of handling.

Assembly of the MEA preassembly is efficiently achieved through the use of a jig alignment fixture 10, which is preferably horizontally disposed to facilitate alignment of the components, as shown in FIG. 1. Alignment pins 11, 12 are used to assure proper alignment among the components, which each have alignment holes. The alignment fixture is also used for assembly of a proton exchange membrane fuel cell stack from one or more “MEA preassemblies” and bi-polar plates.

Before the MEA preassembly is to be assembled, the component parts are obtained, which are specified as follows. The MEA 25 is manufactured with a catalyzed central area 26 and a surrounding area (perimeter) 27 that is not catalyzed. The non-catalyzed area has alignment holes 28 and 29 that are specified to precisely align with the dowel pins 11, 12 within a tolerance of 0.003 inches and preferably to 0.001 inches. Channels or slots 22 are also specified to be provided that are open to channels in a fuel cell stack for gas distribution. Incorporated by reference herein is U.S. 2003-0180603 A1 which describes a fuel cell stack having MEAs that can be assembled to form a PEMFC stack configuration with gas distribution channels.

Rigid Thickness Gaskets 31, 32 (Polyester or similar material), of nominal 0.0125-inch thickness, with an RMS surface finish of better than 16 RMS, are pretreated on both faces with a thin film (typically less than 0.0005 inches thick) sealing lubricant prior to initiation of the assembly process. This sealing lubricant is similar to Radio Shack Multi-purpose Lube Gel PN 64-2326. This lubricant provides the desirable feature of affecting a high tack surface treatment of the gasket faces, and permits an adhesive-like bond to be established between the gasket 16, the MEA perimeter 27, and the GDM 33, via application of a clamping load applied to the entire surface of the preassembly.

The assembly procedure is described in the following steps shown in FIG. 1, in which like reference numbers refer to like components of the invention. An MEA protective plastic film 16 (preferably about 0.004″+/−0.001″ thickness) is placed over the alignment pins 11, 12 in step 1. Note that this protective plastic film is normally provided on both faces of MEAs “as delivered”, and must be removed before the MEAs are used in the assembly steps described herein and further, the protective plastic films 16, 17 must be removed before the MEA preassembly is installed into a PEMFC.

In step 2, plastic gasket 31 is aligned onto fixture 10 over the dowel alignment pins 11, 12. Step 3 involves inserting a gas diffusion media (GDM) 33, similar to SGL 10-BB, of a thickness of approximately 0.0165″ “face up” (wet-proofed side facing up) into the close-clearance cutout 35 in the center of the gasket 31. The typical die-cut tolerance stack up between the GDM 33 (or 34) and the gasket (31 or 32) is preferably maintained at less than +/−0.003″ in both the X and Y dimensions, with these dimensions defining the active (catalyzed) area of the cell.

In step 4, after removing one of the normally provided protective plastic film pieces from one of the faces of a MEA that has been dimensioned to fit in the alignment fixture with the other components as shown, the MEA 25 is positioned over the dowel alignment pins 11, 12 with the plastic film removed (exposed) MEA surface “face down” and with the remaining protective plastic film covered surface facing up. Thereafter, it is assured that the PEM lies flat, without any wrinkles on the GDM 33 and gasket 31 combination.

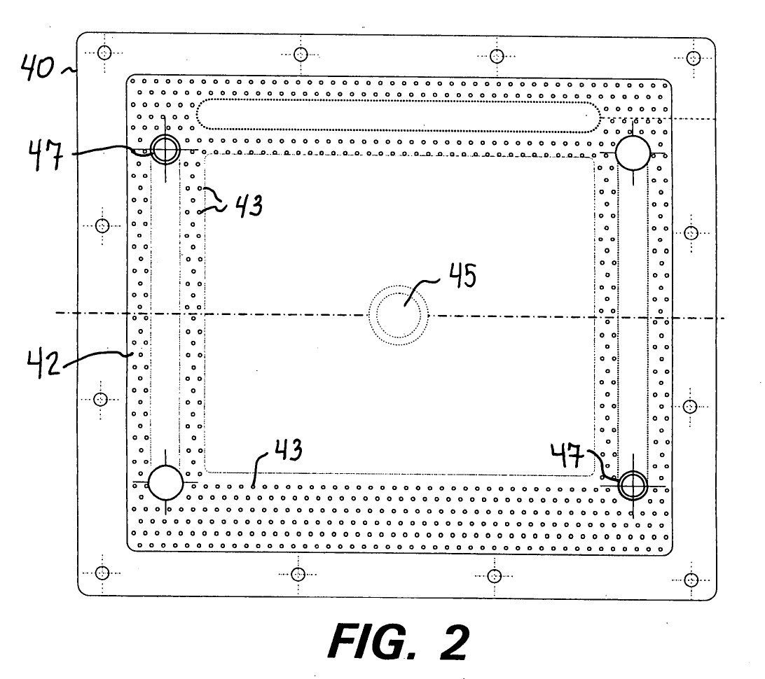

In a preferred embodiment, a vacuum plate fixture, as shown in FIGS. 2-4, is used to assure that the MEA is picked up and placed onto the gasket and GDM without any wrinkling. This is accomplished by placing the MEA 25 onto a platten surface 41 of the vacuum plate 40 and then applying approximately 5 to 10″ H₂O vacuum through opening 45 to the vacuum plate perforated surface area 42 in direct contact with the MEA. Perforated surface area 42 preferably has about 400 holes 43 of 0.030 inches diameter in a 0.125 staggered pattern for holding down the MEA in a wrinkle free manner. Once accomplished, the MEA may then be handled without wrinkling, and subsequently positioned over the alignment fixture 10 “upside down” in preparation to place it over the previously installed gasket and GDM combination. The MEA may then be hand-pressed or mechanically pressed down over the alignment pins 11, 12 of the assembly jig 10 onto the previously installed component elements of the MEA Preassembly. Once accomplished, the vacuum on the platten surface 41 may be removed to release the MEA, and the vacuum plate fixture removed from the alignment fixture. The MEA is held in place by the light tack adhesive forces between the greased gasket 31 and the MEA itself.

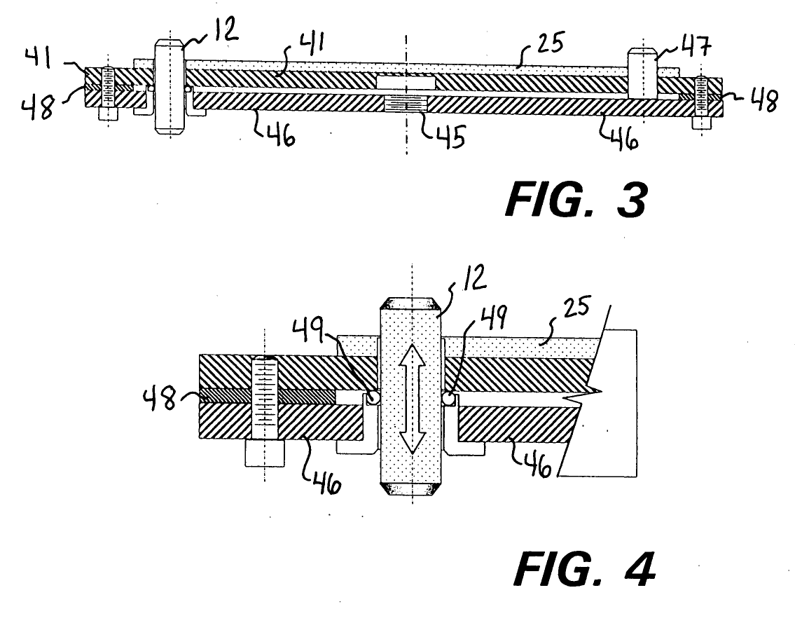

As shown in FIGS. 3 and 4, the vacuum plate has a metal backing plate 46 separated from plate 41 by the thickness (0.060″) of a gasket 47 positioned therebetween. The vacuum is maintained around the dowel pins 11, 12 through O-rings 49. Pins 47, fixed to metal backing plate 46, enter the diagonally opposite holes 28 to ensure alignment of the MEA on the platen surface 42. The pins 47 are of a height that does not interfere with the subsequent positioning of the MEA into position in contact with the GDM and gasket with the dowels 11, 12.

In step 5, after removing the other plastic film normally provided for a MEA, a second gasket 32 (same as 31) is placed over the dowel alignment pins 11, 12, and pressed down snugly against the outer perimeter of the MEA. Further, a second GDM 34 (same as 33) is placed “face down” (wet-proofed side facing down) into the close-tolerance cutout of the second gasket against the exposed surface of the MEA. A second sheet of the MEA protective plastic film is then placed over the five element MEA Preassembly.

Thereafter, the MEA Preassembly is ready to be inserted into a press, and a clamping force of at least 150 psig up to 250 psig, uniformly applied to the entire area of the MEA Preassembly. This step establishes a cohesive, high-tack bond between the GDMs, the sandwiched MEA, and the respective Gaskets, thereby permitting the MEA Preassembly to be easily handled during any subsequent assembly operations into either a single or a multicell stack configuration. The MEA Pre-Assembly may then be removed and set aside, for later final assembly.

The procedure or method described above may be modified to allow for preparation of any number of MEA Preassemblies, up to the total number required for a full stack, as follows.

Repeat steps 2 through 6 as many times as necessary to provide the total desired number of MEA Preassemblies required for a full stack. Place the entire stack of MEA Preassemblies into a press and apply a clamping force of at least 150 psig, up to 250 psig, applied to the full area. Remove the MEA Pre-Assemblies, and set aside for later final assembly. This procedure is amenable to being realized via either a manual or an automated “pick-and-place process of manufacturing for the MEA Preassemblies.

Upon completion of the process described above, to build the desired number of MEA preassemblies, a simple two-step final assembly process may then be employed to build a multicell stack. This process is accomplished by successively sandwiching MEA Pre-Assemblies between successive Bi-Polar Plates until the desired number of cells is reached.

A single cell is built by first placing a Bi-Polar Plate or End Collector Plate over the dowel alignment pins, followed by successive MEA Preassemblies and bi-polar plates The process is repeated until the total desired number of cells is realized. By way of example only, a 32-cell stack configuration may thereby be rapidly assembled by either manual process, or by an automated ‘pick and place’ mechanism in under 1 minute. Completion of the PEMFC stack assembly is then accomplished with the final addition of any required Anode and Cathode Collector Plates and/or End Gas Distribution Plates, installation of associated Clamping Hardware in a final step to achieve the desired uniform clamping force.

While preferred embodiments have been set forth herein, further embodiments, modifications and variations are contemplated according to the present invention.

1. A method of assembling a membrane electrode assembly (MEA) preassembly, comprising the steps of:
aligning a first gas diffusion media within a cutout portion of a first gasket on dowel pins of an alignment fixture;
placing a MEA in alignment with respect to said first gasket and said first gas diffusion media on said alignment fixture so that one side of the MEA is in contact with said first gas diffusion media;
positioning a second gas diffusion media within a cutout portion of a second gasket on the dowel pins of said alignment fixture on the other side of said MEA to provide a MEA preassembly.

2. The method of assembling a MEA preassembly as set forth in claim 1, further including:
applying grease on the surfaces of said first and second gaskets prior to assembly of said first and second gaskets on said alignment fixture.

3. The method of assembling a MEA preassembly as set forth in claim 2, further comprising first aligning a protective plastic film on said alignment fixture and placing a second protective plastic film on the alignment fixture.

4. A method of assembly according to claim 1, further comprising clamping said assembled first gas diffusion media, said MEA and said second gas diffusion media together with at least 150 psig to 250 psig uniformly in the entire area of the MEA.

5. A method of assembly of a proton exchange membrane fuel cell stack, comprising assembling a plurality of said MEA preassemblies assembled according to claim 1, between successive bi-polar plates using said alignment fixture.

6. A method of assembling a MEA preassembly as set forth in claim 1, further including applying vacuum through a vacuum plate in contact with said MEA in order to manipulate said MEA in said step of placing said MEA in alignment with respect to said first gasket and said first gas diffusion media on said alignment fixture.
